(19) United States
(12) Patent Application Publication
(10) Pub. No.: US 2010/0079483 A1
(43) Pub. Date: Apr. 1, 2010

(54) Image processing apparatus, image processing method, and program

(75) Inventors: Hiromasa Naganuma, Chiba (JP); Masashi Ota, Tokyo (JP); Toshimichi Hamada, Tokyo (JP); Kiyoshi Ikeda, Kanagawa (JP); Yoichi Hirota, Kanagawa (JP); Naomasa Takahashi, Chiba (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/586,591

(22) Filed: Sep. 24, 2009

(30) Foreign Application Priority Data
Sep. 26, 2008 (JP) P2008-249276

(51) Int. Cl. G09G 5/02

(52) U.S. Cl. 345/600

(57) ABSTRACT

An image processing apparatus prevents the inappropriate application of error diffusion and adaptively applies palette conversion functions according to the properties of the source. A processing subsystem performs various processing with respect to an original video source. A palette converter converts the palette bit depth, having modifiable palette conversion functions for creating the illusion of expressing the pre-conversion palette tones in the post-conversion image. A controller turns on the palette converter, turns off the palette converter, or modifies the palette conversion functions thereof, in accordance with at least original source information and system-wide settings information.

### CROSS-REFERENCE TO RELATED APPLICATION

The present application claims priority from Japanese Patent Application No. JP 2008-249276 filed in the Japanese Patent Office on Sep. 26, 2008, the entire content of which is incorporated herein by reference.

### BACKGROUND OF THE INVENTION

1. Field of the Invention

The present invention relates to an image processing apparatus, an image processing method, and a program having palette (i.e., gradation) conversion functions for converting bit depth (i.e., bit number).

2. Description of the Related Art

Consider, for example, an image having N-bit pixel values. If such an image is to be displayed by a display apparatus that displays images having M-bit pixel values (where M is smaller than N), then the N-bit image is first converted to an M-bit image. In other words, palette conversion is conducted to convert the palette of the image.

One method for converting an image from an N-bit palette to an M-bit palette involves simply truncating the N-bit pixel values to M bits by discarding the least-significant bits, and then quantizing the result into M-bit pixel values.

In this quantizing palette conversion, a 256-tone palette (=2⁸) can be expressed using 8 bits, while only a 16-tone palette (=2⁴) can be expressed using 4 bits, for example. For this reason, if palette conversion is conducted by discarding the least-significant bits of an 8-bit grayscale image and quantizing the result using the most-significant 4 bits, then banding will occur where the tones change.

There exist palette conversion methods to prevent the occurrence of such banding and create the illusion of expressing the pre-conversion palette tones in the post-conversion image. Error diffusion methods are one example of the above. By means of such error diffusion methods, the palette of a 256-tone image, for example, can be converted to obtain a 16-tone image that appears to express 256 tones to the human eye, while actually using only 16 tones.

In other words, if the least-significant bits are simply discarded, the quantization error in the displayed image becomes apparent, which makes it difficult to preserve picture quality. Consequently, there also exist error diffusion methods that take into account the characteristics of human vision and conduct delta-sigma modulation to modulate such quantization error into the upper range of the image. In error diffusion, quantization error is typically filtered using a two-dimensional (2D) filter. Such 2D filters include the Jarvis, Judice, and Ninke filter, as well as the Floyd-Steinberg filter (see, for example, Hitoshi Kiya, “Yoku wakaru dijitaru gazou shori” (Digital image processing made easy), 6th ed., CQ Publishing, January 2000, p. 196-213).

### SUMMARY OF THE INVENTION

Meanwhile, it is also conceivable to conduct 1D delta-sigma modulation rather than 2D.

However, in an image processing apparatus having palette conversion functions, if 1D palette conversion is used on an input source, then large, visibly noticeable noise might be produced. Moreover, variation in the color components orthogonal to the palette conversion might also be noticed. This is because an effect similar to ordinary dithering is produced in the direction orthogonal to the 1D palette conversion. As a result, typical error diffusion techniques are inadvertently applied to the orthogonal components.

In addition, in some video playback systems an original source might be output at a specific picture size. If error diffusion techniques are applied to such a system, error diffusion will be applied to the signals internally processed in the video system.

The problem in this case is that since a signal different from the original signal is processed, error diffusion is applied even in cases where its application is inappropriate for a given source. As a result, overall image expression is hardly improved, and instead may lead to a reduced S/N ratio, one of the demerits of dithering.

It is thus desirable to provide an image processing apparatus, an image processing method, and a program able to prevent the inappropriate application of error diffusion and adaptively apply palette conversion functions in accordance with the properties of the source.

An image processing apparatus in accordance with a first embodiment of the present invention includes: a processing subsystem configured to perform various processing with respect to an original video source; a palette converter configured to convert the palette bit depth, having modifiable palette conversion functions for creating the illusion of expressing the pre-conversion palette tones in the post-conversion image; and a controller configured to turn on the palette converter, turn off the palette converter, or modify the palette conversion functions thereof, in accordance with at least original source information and system-wide settings information.

An image processing method in accordance with a second embodiment of the present invention includes the steps of: performing various processing with respect to an original video source; turning on a palette converter, turning off a palette converter, or modifying the palette conversion functions thereof, in accordance with at least original source information and system-wide settings information; stopping the expression of the palette conversion functions when the palette converter has been turned off; and when the palette converter has been turned on, converting the palette bit depth of the image signal subjected to the various processing so as to create the illusion of expressing the pre-conversion palette tones in the post-conversion image.

A program in accordance with a third embodiment of the present invention causes a computer to execute image processing that includes the steps of: performing various processing with respect to an original video source; turning on a palette converter, turning off a palette converter, or modifying the palette conversion functions thereof, in accordance with at least original source information and system-wide settings information; stopping the expression of the palette conversion functions when the palette converter has been turned off; and when the palette converter has been turned on, converting the palette bit depth of the image signal subjected to the various processing so as to create the illusion of expressing the pre-conversion palette tones in the post-conversion image.

According to an embodiment of the present invention, the inappropriate application of error diffusion is prevented, and palette conversion functions are adaptively applied in accordance with the properties of the source.

### BRIEF DESCRIPTION OF THE DRAWINGS

FIG. 1 is a block diagram illustrating an exemplary basic configuration of a video-system image processing apparatus having 1D SBM functions in accordance with an embodiment of the present invention;

FIG. 2 is a block diagram illustrating an exemplary configuration of a palette converter constituting a major part of an SBM processor in accordance with an embodiment of the present invention;

FIG. 3 illustrates an exemplary configuration of the dither adder shown in FIG. 2;

FIG. 4 illustrates the sequence of pixels to be subjected to palette conversion;

FIG. 5 illustrates information obtained in the HDMI Spec. 1.3;

FIG. 6 is a flowchart for explaining a process for switching the filter coefficients of an HPF according to information from respective blocks in an embodiment of the present invention;

FIG. 7 illustrates examples of source video information; and

FIG. 8 is a block diagram illustrating an exemplary configuration of a recording and playback apparatus to which an image processing apparatus in accordance with an embodiment of the present invention has been applied.

### DESCRIPTION OF THE PREFERRED EMBODIMENTS

Hereinafter, embodiments of the present invention will be described in association with the attached drawings. The description will proceed in the following order:

1. First embodiment (exemplary basic configuration of image processing apparatus)

2. Second embodiment (exemplary configuration of recording and playback apparatus with image processing apparatus applied thereto)

### 1. First Embodiment

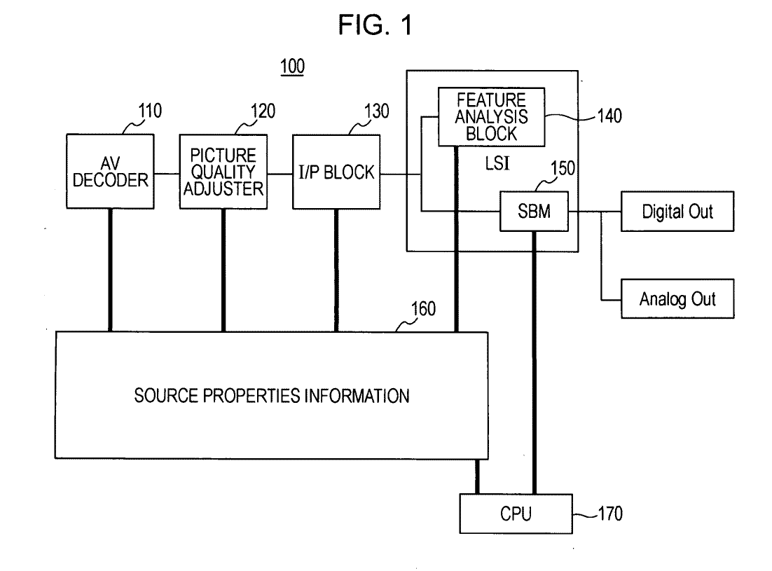

FIG. 1 is a block diagram illustrating an exemplary basic configuration of a video-system image processing apparatus having 1D SBM functions in accordance with an embodiment of the present invention.

The video signal image processing apparatus 100 in accordance with the present embodiment implements 1D Super Bit Mapping (SBM) functions. Herein, SBM refers to a technology enabling signal transmission without loss of multi-bit components by adding noise in the upper range coordinated with human vision characteristics when quantizing a multi-bit signal processing result into bits.

The image processing apparatus 100 of the present embodiment is configured to conduct SBM in accordance with the properties of the source. In other words, in the present embodiment, 1D SBM is not simply applied to an input video signal. Instead, SBM is adaptively controlled on the basis of the original source information and information regarding the final output. For example, the activation or deactivation of SBM may be controlled by switching the coefficients of a high-pass filter (HPF, to be later described) according to the source.

The image processing apparatus 100 shown in FIG. 1 includes: an AV decoder 110, a picture quality adjuster 120, an I/P block 130, a feature analysis block 140, an SBM processor 150, source properties information storage 160, and a CPU 170 that acts as a controller. In the present embodiment, the AV decoder 110, the picture quality adjuster 120, the I/P block 130, and feature analysis block 140 collectively form a processing subsystem.

The AV decoder 110 decodes the compressed data of input audio and video according to a predetermined compression coding format (i.e., the AV decoder 110 decompresses compressed data). Stated differently, the AV decoder 110 converts an original source into a video signal.

The picture quality adjuster 120 has functions for adjusting the picture quality of the video signal decoded by the AV decoder 110.

The I/P (interlaced/progressive) block 130 conducts IP conversion and outputs the result to the feature analysis block 140 and the SBM processor 150.

The feature analysis block 140 acquires feature point information for the video signal. The feature analysis block 140 may acquire, for example, flat parts, gray noise parts, mosquito parts, and detail parts, all on a per-pixel basis. In addition, the feature analysis block 140 may also acquire other information with respect to particular pixels, including black parts, edge intensity information, flat part information, and chroma level information.

Under control by the CPU 170, the SBM processor 150 may deactivate SBM, or modify how SBM is conducted by switching the coefficients of a high-pass filter (HPF, to be later described) in accordance with the source.

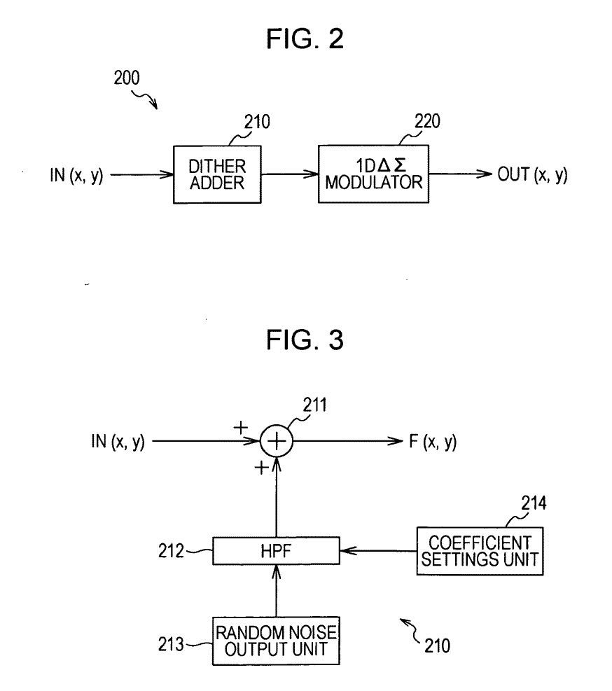

FIG. 2 is a block diagram illustrating an exemplary configuration of a palette converter constituting a major part of the SBM processor in accordance with the present embodiment.

The palette converter 200 has palette conversion functions for taking the video signal of an 8-bit image that has been expanded to a 14-bit image by noise reduction processing, for example, and converting the palette of the video signal to a bit depth (such as 8-bit, 10-bit, or 12-bit) that can be processed and displayed by a given display device.

The palette converter 200 includes a dither adder 210 and a 1D delta-sigma modulator 220.

The dither adder 210 dithers target pixels by adding random noise to the pixel values IN(x,y) forming those target pixels, and then outputs the results to the 1D delta-sigma modulator 220.

The 1D delta-sigma modulator 220 performs 1D delta-sigma modulation with respect to the dithered target pixels from the dither adder 210, and outputs an image made up of the resulting pixel values OUT(x,y) as the output of the palette converter 200.

FIG. 3 illustrates an exemplary configuration of the dither adder 210 shown in FIG. 2.

As shown in FIG. 3, the dither adder 210 includes an arithmetic unit 211, a high-pass filter (HPF) 212, a random noise output unit 213, and a coefficient settings unit 214.

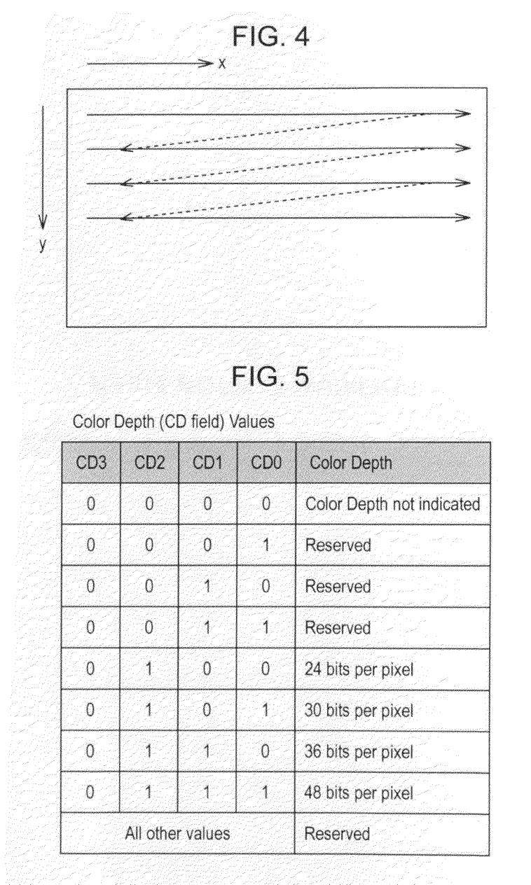

The arithmetic unit 211 is supplied with the pixel values IN(x,y) of the target pixels in raster scan order, as shown in FIG. 4. The arithmetic unit 211 is also supplied with the output from the HPF 212. The arithmetic unit 211 adds the output of the HPF 212 to the target pixel values IN(x,y), and then supplies the resulting sum values to the 1D delta-sigma modulator 220 as the dithered pixel values F(x,y).

On the basis of filter coefficients set by the coefficient settings unit 214, the HPF 212 filters the random noise output by the random noise output unit 213, and then supplies the resulting high-range component of the random noise to the arithmetic unit 211.

The random noise output unit 213 generates random noise according to a Gaussian distribution, for example, and outputs the result to the HPF 212.

Principally, the coefficient settings unit 214 configures the HPF 212 by determining filter coefficients HPF-CE1, HPF-CE2, or HPF-CE3. These filter coefficients are determined on the basis of the spatial frequency characteristics of human vision, as well as the resolution of the display device. In the present embodiment, the coefficient settings unit 214 selects one from among the filter coefficients HPF-CE1, HPF-CE2, and HPF-CE3 according to control instructions from the CPU 170.

As thus described above, in the dither adder 210, the coefficient settings unit 214 selects filter coefficients for the HPF 212 from among the filter coefficients HPF-CE1, HPF-CE2, and HPF-CE3, according to instructions from the CPU 170. Subsequently, the HPF 212 performs arithmetic computations, such as taking the sum of the products between the filter coefficients set by the coefficient settings unit 214 and the random noise output by the random noise output unit 213. In so doing, the HPF 212 filters the random noise output be the random noise output unit 213.

As a result, the HPF 212 supplies the high-range component of the random noise to the arithmetic unit 211.

The arithmetic unit 211 adds together the 14-bit pixel values IN(x,y) of the target pixels and the high-range component of the random noise from the HPF 212. This results in 14-bit sum values equal in bit length to that of the target pixels, for example, or in sum values of greater bit length. The arithmetic unit 211 then outputs the resulting sum values to the 1D delta-sigma modulator 220 as the dithered pixel values F(x,y).

In addition to controlling overall operation of the apparatus, the CPU 170 does not simply apply 1D SBM to an input video signal, but instead adaptively controls SBM on the basis of original source information and information regarding the final output. For example, the CPU 170 may deactivate SBM, or modify how SBM is conducted by switching the coefficients of a high-pass filter (HPF, to be later described) according to the source.

The CPU 170 conducts on/off control of the SBM processor 150 in accordance with various information. The CPU 170 also conducts an automatic switching control to switch the SBM bit length according to information from a television (TV). In accordance with information from the AV decoder 110, the picture quality adjuster 120, the I/P block 130, and the feature analysis block 140, the CPU 170 switches the filter coefficients of the HPF 212 in the dither adder 210 of the palette converter 200 provided in the SBM processor 150.

SBM is adaptively controlled in the present embodiment for the following reason.

If 1D SBM is simply applied to an input video signal, noise components orthogonal to the SBM direction might become apparent. For this reason, 1D SBM is controlled using the results of image analysis such that orthogonal noise is not readily apparent.

In addition, in some video playback systems an original source might be output at a specific picture size. If error diffusion techniques are applied to such a system, error diffusion will be applied to the signals internally processed in the video system.

The problem in this case is that since a signal different from the original signal is processed, error diffusion is applied even in cases where its application is inappropriate for a given source. As a result, overall image expression is hardly improved, and instead may lead to a reduced S/N ratio, one of the demerits of dithering.

Since the original source is thus output by the video signal playback system in an altered state, SBM is herein controlled such that the results from a plurality of processes applied to the original source are used to modify the SBM settings and further increase the effects of SBM.

A specific example of the control performed by the CPU 170 of the image processing apparatus 100 shown in FIG. 1 will now be described.

### [SBM On/Off Control]

The CPU 170 switches SBM on or off in accordance with usage information indicating whether digital out or analog out is being used. Alternatively, the CPU 170 may select filter coefficients for the HPF 212 from among HPF-CE1, HPF-CE2, and HPF-CE3 according to digital or analog classification.

[Using Information from the TV During Digital Out]

In the case of digital out by means of HDMI, for example, the CPU 170 may use HDMI monitor information, such as that obtained in the HDMI Spec. 1.3 shown in FIG. 5, to automatically switch the SBM bit length. For example, 14-bit values may be controlled to become 12-bit, 10-bit, or 8-bit values.

[Switching HPF Filter Coefficients According to Information from Each Block]

The CPU 170 switches the filter coefficients of the HPF 212 in the dither adder 210 of the palette converter 200 provided in the SBM processor 150 in accordance with information from the AV decoder 110, the picture quality adjuster 120, the I/P block 130, and the feature analysis block 140. The CPU 170 also turns SBM on or off.

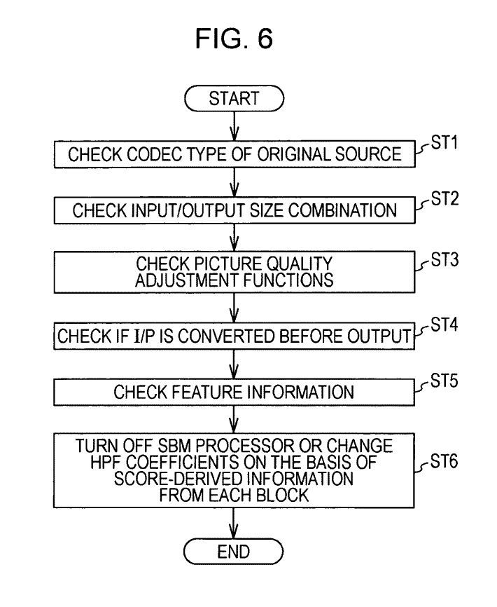

FIG. 6 is a flowchart for explaining a process for switching the filter coefficients of the HPF according to information from respective blocks in the present embodiment.

### (Step ST1)

In step ST1, the codec type of the original source is checked. The codec type may be MPEG2, MPEG4-AVC, or VC-1, for example.

### (Step ST2)

In step ST2, the combination of input and output size is checked. Exemplary input sizes are given below.

Input: 1920×1080/24p, 1920×1080/60i, 1440×1080/60i, 1280×720/60p, 720×480/60p, 720×480/60i, etc.

Exemplary output sizes are given below.

Output: 1920×1080/60p, 1920×1080/24p, 1920×1080/60i, 1280×720/60p, 720×480/60p, 720×480/60i.

### (Step ST3)

In step ST3, the picture quality adjustment functions are checked. For example, it may be checked whether functions such as noise reduction (NR) are on or off.

### (Step ST4)

In step ST4, it is checked whether I/P conversion is being performed before image output. For example, it may be checked if 60i is being converted to 60p.

### (STEP ST5)

In step ST5, the feature information from the feature analysis block 140 is checked. The information regarding the target pixels may include black parts, edge intensity information, flat part information, and chroma level information, for example.

### (Step ST6)

In step ST6, information derived from scores obtained from each block is used as a basis for turning the SBM processor 150 off, or alternatively, for changing the filter coefficients of the HPF 212 to the filter coefficients HPF-CE1, HPF-CE2, or HPF-CE3.

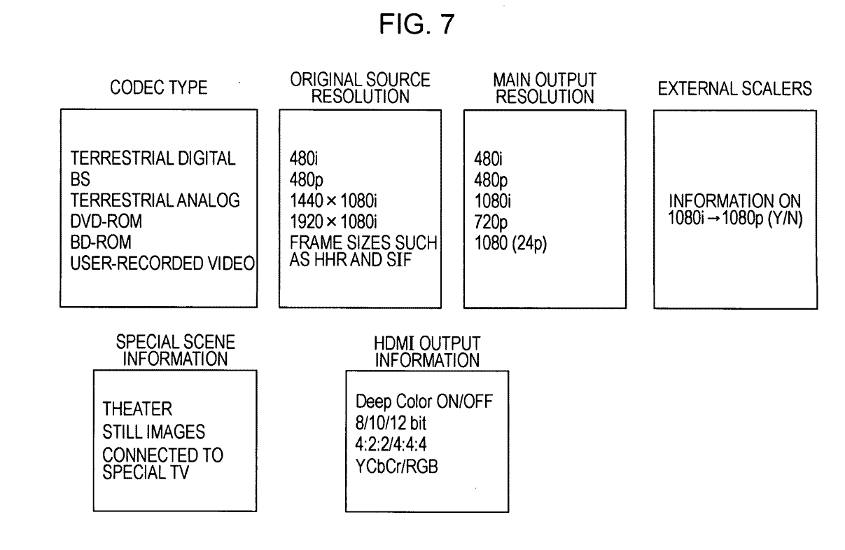

FIG. 7 illustrates examples of source video information. Source video information includes in categories such as codec type, original source resolution, main output resolution, external scalers, special scene information, and HDMI output information.

The foregoing thus describes the configuration and functions relating to the SBM functions of a first embodiment of the present invention.

Hereinafter, the configuration and functions of a recording and playback apparatus to which the image processing apparatus shown in FIG. 1 has been applied will be described as a second embodiment of the present invention.

### 2. Second Embodiment

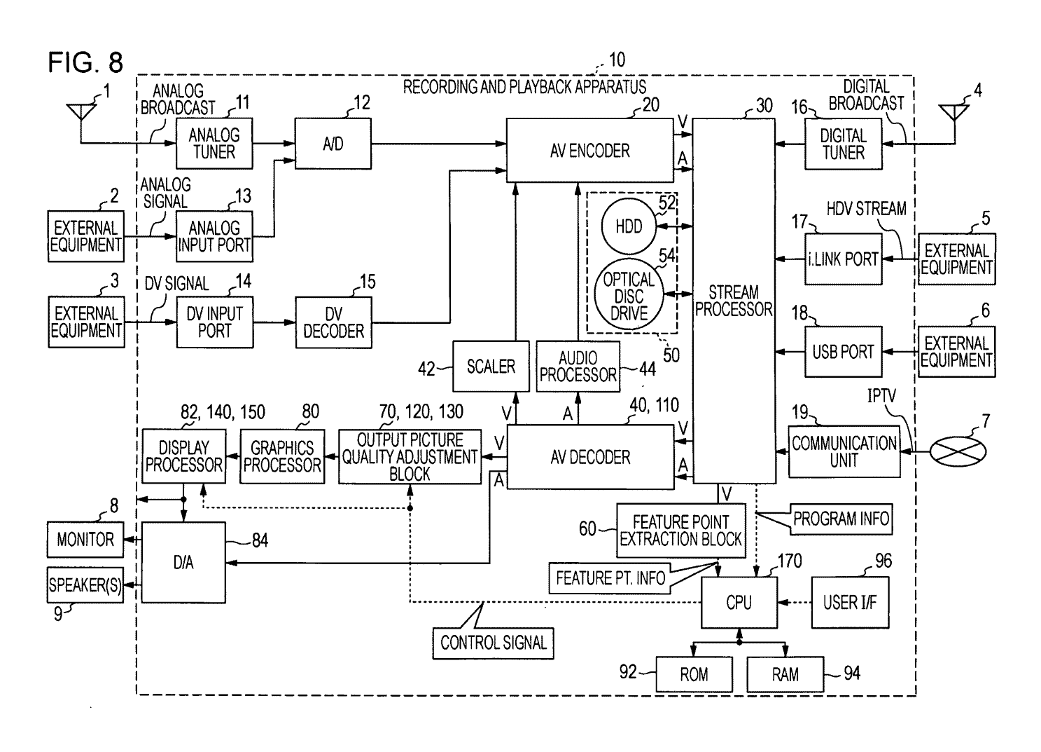

FIG. 8 is a block diagram illustrating an exemplary configuration of a recording and playback apparatus to which an image processing apparatus in accordance with an embodiment of the present invention has been applied.

The recording and playback apparatus 10 in accordance with the present embodiment is configured as an apparatus able to both record externally-provided video content onto a recording medium such as a hard disk drive (HDD) or optical disc, and in addition, play back video content that has been recorded onto such a recording medium. The recording and playback apparatus 10 may be configured as a multi-function device that operates as both an optical disc recorder using an optical disc as a recording medium, as well as an HDD recorder using a hard disk as a recording medium.

The video content (also referred to herein simply as “content”) may be the content of a television broadcast program received from a broadcast station, an externally-input video program, or a video program read from a medium such as a DVD or BD (Blu-ray Disc™), for example.

Herein, television broadcasts includes program content broadcast via airwaves, such as terrestrial digital or analog broadcasts, BS (Broadcasting Satellite) broadcasts, and CS (Communication Satellite) broadcasts, for example. Furthermore, television broadcasts also includes program content delivered via a network, such as cable television broadcasts, IPTV (Internet Protocol TV), and VOD (Video On Demand).

### [Summary of Recording and Playback Apparatus]

The characteristics of the recording and playback apparatus 10 in accordance with the present embodiment will now be summarized.

When recording or playing back video content, the recording and playback apparatus 10 in accordance with the present embodiment analyzes the entire video of the video content, and acquires feature point information expressing characteristic portions of the content in advance. Then, when playing back that video content another time, the recording and playback apparatus 10 applies the feature point information to adjust the picture quality of the playback video.

In other words, when recording program content, for example, the recording and playback apparatus 10 in accordance with the present embodiment analyzes the content of that program and records information expressing the features of that program's video (i.e., feature point information). When subsequently replaying the program content, the recording and playback apparatus 10 uses the feature point information to dynamically control the output picture quality functions for that program content, thereby improving the picture quality of the output video.

More specifically, when recording video content such as a television broadcast program or a movie, the recording and playback apparatus 10 analyzes the entire video of the video content. The recording and playback apparatus 10 then detects features in the program content, such as scene changes, fades, cross-fades, scenes where characters appear, and scenes with large tickers or captions. These features are recorded as feature point information.

Subsequently, when controlling the output picture quality adjustment functions during playback of the video content, the recording and playback apparatus 10 applies the feature point information as feedback with respect to the ordinary control parameters for picture quality adjustment, thereby dynamically controlling output picture quality adjustment in accordance with features in the video.

At this point, the user is also able to select how much the feature point information will affect picture quality adjustment by toggling an unlocked configuration setting.

Hereinafter, the configuration for realizing the above in a recording and playback apparatus 10 in accordance with the present embodiment will be described in detail.

### [Hardware Configuration of Recording and Playback Apparatus]

A hardware configuration of the recording and playback apparatus 10 in accordance with the present embodiment will now be described in association with FIG. 8.

FIG. 8 is a block diagram illustrating a configuration of the recording and playback apparatus 10 in accordance with the present embodiment. In FIG. 8, “A” indicates an audio signal, while “V” indicates a video signal.

As shown in FIG. 8, the recording and playback apparatus 10 includes an analog tuner 11, an A/D converter 12, an analog input port 13, a DV (Digital Video) input port 14, a DV decoder 15, and a digital tuner 16.

The recording and playback apparatus 10 also includes an i.LINK port 17, a USB port 18, a communication unit 19, an AV encoder 20, a stream processor 30, an AV decoder 40, a scaler 42, and an audio processor 44.

The recording and playback apparatus 10 furthermore includes an HDD 52, an optical disc drive 54, a feature point extraction block 60, an output picture quality adjustment block 70, a graphics processor 80, a display processor 82, and a D/A converter 84.

The recording and playback apparatus 10 also includes ROM (Read-Only Memory) 92, RAM (Random Access Memory) 94, a user interface 96, and a CPU (Central Processing Unit) 170.

In the recording and playback apparatus 10 shown in FIG. 8, the AV decoder 40, the output picture quality adjustment block 70, the graphics processor 80, the display processor 82, and the video processing subsystem of the CPU 170 have functions similar to those of the image processing apparatus shown in FIG. 1.

It is possible to form the display processor 82 having functional blocks equivalent to the feature analysis block 140 and the SBM processor 150. It is also possible to incorporate the functions of the feature analysis block 140 into the feature point extraction block 60 rather than the display processor 82.

SBM processing and its control has already been described in detail and in association with FIGS. 1 to 6, and thus further description thereof is omitted herein.

Hereinafter, the configuration and functions of the respective components of the recording and playback apparatus 10 will be described.

The analog tuner 11 tunes to a desired channel among the airwaves received by an antenna 1 for analog broadcasts, demodulates the electromagnetic waves for that channel, and generates an program content receiver signal (i.e., an audio/video analog signal). Additionally, the analog tuner 11 performs predetermined video signal processing with respect to the receiver signal, such as intermediate frequency amplification, color signal separation, color difference signal generation, and sync signal extraction, for example. The analog tuner 11 then outputs the resulting video signal.

The A/D converter 12 acquires audio and video analog signals input from the analog tuner 11 or the analog input port 13, converts the acquired analog signal into a digital signal at a predetermined sampling frequency, and outputs the result to the AV encoder 20.

The analog input port 13 acquires audio and video analog signals input from external equipment 2.

Similarly, the DV input port 14 acquires audio and video DV signals input from external equipment 3, such as a DV-compatible digital video camera.

The DV decoder 15 decodes such DV signals and outputs the result to the AV encoder 20.

The digital tuner 16 tunes to a desired channel among the airwaves received by an antenna 4 for satellite or terrestrial digital broadcasts, and then outputs the audio and video digital data (i.e., bitstreams) for the program content on that channel to the stream processor 30.

Other external input ports such as the i.LINK port 17 and the USB port 18 may be connected to external equipment 5 and 6, such as an HDV (High Definition Video)-compatible digital video camera. Audio and video HDV signals (i.e., streams) transferred by IEEE 1394 from the external equipment 5 are input into the stream processor 30 via the i.LINK port 17.

The communication unit 19 exchanges various data with external apparatus (not shown) via an IP network such as an Ethernet network 7. For example, the communication unit 19 may receive audio and video signals for IPTV program content delivered via the Ethernet network 7, and then output such signals to the stream processor 30.

The AV encoder 20 is hardware configured by way of example as an encoding unit that compresses and encodes audio and video signals. The AV encoder 20 acquires audio and video signals input from components such as the A/D converter 12, the DV decoder 15, as well as the scaler 42 and audio processor 44 to be later described, and encodes the signals using a predetermined codec type.

The AV encoder 20 is a high-performance encoder compatible with both HD (High Definition) and SD (Standard Definition) video, and thus is able to encode video signals at HD resolutions in addition to SD resolutions.

In addition, the AV encoder 20 is also compatible with both stereo and multi-channel audio, and is thus able to encode multi-channel audio signals in addition to two-channel audio signals.

The AV encoder 20 encodes the audio and video signals of content to be recorded at a bit rate corresponding to a recording mode determined by the CPU 170. The AV encoder 20 outputs the compressed data (i.e., bitstream) of audio/video signals encoded in this way to the stream processor 30.

When recording or playing back data to or from a recording medium, the stream processor 30 processes the data (i.e., the stream) to be recorded or played back in a predetermined way. For example, when recording data, the stream processor 30 multiplexes and encrypts the compressed data encoded by the AV encoder 20, and then records the result to a recording medium in the recording unit 50 while performing buffer control. (The recording unit 50 includes the HDD 52 and the optical disc drive 54.) In contrast, when playing back data, the stream processor 30 reads compressed data from a recording medium in the recording unit 50, decrypts and demultiplexes the read data, and then outputs the result to the AV decoder 40.

The AV decoder 40 is hardware configured by way of example as a decoding unit that decodes compressed audio and video signals. The AV decoder 40 acquires the compressed data of audio and video signals input from the stream processor 30, and decodes (i.e., decompresses the compressed data) using a predetermined codec type.

The codec types used by the above AV encoder 20 and AV decoder 40 for video may include MPEG-2, H.264 AVC (Advanced Video Coding), and VC1, for example. For audio, the codec types may include Dolby AC3, MPEG-2 AAC (Advanced Audio Coding), and LPCM (Linear Pulse Code Modulation), for example.

Furthermore, as described above, audio/video signals in a diverse array of formats may be input into the recording and playback apparatus 10 from external sources. The formats (i.e., picture sizes) of such video signals may include 480i, 480p, 720p, 1080i, and 1080p, for example, depending on the video quality.

For example, 1080i refers to a video signal having 1080 viewable horizontal scan lines (out of 1125 total) in interlaced format, transmitted at a frame rate of 30 fps. The resolution of a 1080i signal is either 1920×1080 or 1440×1080 pixels.

On the other hand, 720p refers to a video signal having 720 viewable horizontal scan lines (out of 750 total) in progressive format, transmitted at a frame rate of 60 fps. The resolution of a 720p signal is either 1280×720 or 960×720 pixels.

Among the video signal formats given above, 480i and 480p are classified in the SD video category (hereinafter referred to as the SD category) for their small numbers of scan lines and low resolutions.

In contrast, 720p, 1080i, and 1080p are classified in the HD video category (hereinafter referred to as the HD category) for their large numbers of scan lines and high resolutions.

Meanwhile, the audio signal formats (i.e., numbers of channel) may, for example, include 1 CH, 2 CH, 5.1 CH, 7.1 CH, 4 CH, 5 CH, and 6 CH.

For example, 5.1 CH refers to a multi-channel audio signal output from six speakers: five speakers positioned at the front center, front right, front left, rear right, and rear left with respect to the listener, and a sixth subwoofer for producing low-frequency effects (LFE).

Among the audio signal format given above, 1 CH (monaural) and 2 CH (stereo) are classified in the stereo audio category (hereinafter referred to as the stereo category) for their relatively small numbers of channel and low sound quality.

In contrast, 5.1 CH, 6.1 CH, 7.1 CH, 4 CH, and 5 CH are classified in the multi-channel audio category (hereinafter referred to as the multi-channel category) for their relatively large numbers of channels and high sound quality.

The recording and playback apparatus 10 also includes a format converter for converting various audio/video signals input in one of the above formats to a predetermined recording format compatible with a particular recording medium. The format converter includes the scaler 42 (a video format converter) and the audio processor 44 (an audio format converter).

On the basis of instructions from the CPU 170, the scaler 42 converts the format of a video signal input from the AV decoder 40 into a predetermined recording format. (In other words, the scaler 42 adjusts the picture size.) For example, if a video signal is input in a format belonging to the HD category, such as 720p or 1080p, then the scaler 42 may convert the video signal into the predetermined recording format 1080i, which is compatible with the recording medium. After converting the picture size, the scaler 42 outputs the resulting video signal to the AV encoder 20.

In this way, the scaler 42 not only includes typical scaler functions for converting picture sizes between HD and SD resolutions, but also includes functions for converting picture sizes among diverse formats belonging to the same video format category. Herein, such picture size conversion functions include converting video from 720p to 1080i in the HD category, for example.

On the basis of instructions from the CPU 170, the audio processor 44 converts the format of an audio signal input from the AV decoder 40 into a predetermined recording format. (In other words, the audio processor 44 modifies the number of channels.) For example, if an audio signal is input in a format belonging to the multi-channel category, such as 7.1 CH, 4 CH, or 5 CH, then the audio processor 44 may convert the audio signal into the predetermined multi-channel recording format 5.1 CH, which is compatible with the recording and playback apparatus 10. After modifying the number of channels, the audio processor 44 outputs the resulting audio signal to the AV encoder 20.

In this way, the audio processor 44 not only includes functions for converting channel numbers between different categories of audio formats, but also includes functions for converting channel numbers among diverse formats belonging to the same audio format category. Herein, such channel number conversion functions include converting audio from 5 CH to 5.1 CH in the multi-channel category, for example.

The recording and playback apparatus 10 also includes a recording unit 50 that records information such as the audio and video data of content to a recording medium. The recording unit 50 in the recording and playback apparatus 10 in accordance with the present embodiment may include a hard disk drive (HDD) 52 and an optical disc drive 54, for example.

The HDD 52 reads and writes various information from and to a hard disk, which acts as a recording medium. For example, the HDD 52 may record to the hard disk audio/video signal streams input from the stream processor 30. In addition, the HDD 52 may read data recorded onto the hard disk, and output the read data to the stream processor 30.

Similarly, the optical disc drive 54 reads and writes various information from and to an optical disc, which acts as a recording medium. For example, the user may insert into the optical disc drive 54 a removable recording medium (such as a DVD or BD) sold having video content recorded thereon. In so doing, the optical disc drive 54 is able to read and play back the video content from the removable recording medium.

In this way, the recording unit 50 in the recording and playback apparatus 10 has two major components: the HDD 52 and the optical disc drive 54. By means of these components, content recorded onto the HDD 52 can be recorded onto the optical disc drive 54, and vice versa.

Arbitrary recording media are useable as the recording media described above. For example, magnetic disks such as hard disks may be used, as well as optical media such as next-generation DVDs (such as Blu-Ray discs) and DVD-R, DVD-RW, or DVD-RAM discs.

Alternatively, other arbitrary recording media may be used as the recording media described above, such as magneto-optical or similar optical discs, as well as various semiconductor memory such as flash memory.

Moreover, the recording medium may be a recording medium fixed within the recording and playback apparatus 10, or a removable recording medium that can be loaded and unloaded into and out of the recording and playback apparatus 10.

The feature point extraction block 60 is configured using hardware having functions for analyzing a video signal and extracting information related to feature points in the content video, for example. When recording externally-acquired content onto a recording medium in the recording unit 50, or when playing back content recorded onto a recording medium, the feature point extraction block 60 analyzes the video signal of the content in accordance with instructions from the CPU 170. The feature point extraction block 60 then extracts information expressing feature points in the content video from the video signal, and outputs the resulting information to the CPU 170.

The output picture quality adjustment block 70 is configured as hardware having functions for adjusting output picture quality, for example. When playing back content recorded onto a recording medium in the recording unit 50, the output picture quality adjustment block 70 adjusts the output picture quality of the playback content in accordance with instructions from the CPU 170. At this point, the CPU 170 dynamically controls the operation of the output picture quality adjustment block 70 on the basis of particular content, using feature point information related to the playback content.

When playing back data, the graphics processor 80 generates information such as subtitles or display data indicating configuration settings or operational conditions of the recording and playback apparatus 10. The graphics processor 80 then overlays such display data and subtitles onto the playback video output from the output picture quality adjustment block 70.

The display processor 82 processes the composite video generated by the graphics processor 80, adjusting the picture size according to the output format, for example. The display processor 82 also includes the SBM functions described earlier.

Under control by the CPU 170, the display processor 82 does not simply apply 1D SBM to an input video signal. Instead, SBM is adaptively controlled on the basis of original source information and information regarding the final output. For example, the display processor 82 may deactivate SBM, or modify how SBM is conducted by switching the coefficients of a high-pass filter (HPF) according to the source.

The D/A converter 84 takes digital video signals input from the display processor 82 and digital audio signals input from the AV decoder 40, converts the signals into analog signals, and outputs the results to a monitor 8 and one or more speakers 9.

The CPU 170 functions as both a computational processing apparatus and a control apparatus, and controls respective components in the recording and playback apparatus 10. The CPU 170 executes various processing with the use of RAM 94, following a program stored in ROM 92 or loaded into the RAM 94 from the recording unit 50. The ROM 92 stores information such as programs and computational parameters used by the CPU 170, and also functions as a buffer for reducing access to the recording unit 50 by the CPU 170. The RAM 94 temporarily stores programs executed by the CPU 170, as well as parameters or other information that changes during the execution of such programs. In addition, the CPU 170 also functions as other components, such as a properties information acquirer, an analyzer, a control routine generator, and a picture quality adjustment controller.

The user interface 96 functions as an input unit whereby the user inputs various instructions with respect to the recording and playback apparatus 10. The user interface 96 may include operable keys such as buttons, switches, and levers, or other operable means such as a touch panel or remote control. The user interface 96 also includes an input control circuit that generates input signals in response to input operations performed with respect to the above operable means, and then outputs the generated inputs signals to the CPU 170. By operating the user interface 96, the user of the recording and playback apparatus 10 is able to input various data and issue instructions for processing operations to the recording and playback apparatus 10.

Upon receiving user input made with respect to the user interface 96, the CPU 170 controls the recording or playback of content, or configures the scheduled recording of broadcast programs, for example, on the basis of the user input.

Recording operations performed by the recording and playback apparatus 10 configured as shown in FIG. 8 will now be described. Such recording operations are executed when recording program content that has been scheduled for recording, or when directly recording program content in response to user instructions, for example. Furthermore, such recording operations may also be executed when recording externally-input content, or when dubbing content between the HDD 52 and the optical disc drive 54.

First, a sequence will be described for the case wherein an externally-input analog signal is encoded and recorded onto a recording medium.

Upon receiving an analog television broadcast using the antenna 1, for example, the analog video signal and the analog audio signal output from the analog tuner 11 are digitized by the A/D converter 12. Subsequently, the digital audio and video signals are encoded by the AV encoder 20, and converted into bitstreams. In addition, the digital audio and video signals are multiplexed and encrypted by the stream processor 30, and then recorded onto a recording medium in the HDD 52 or the optical disc drive 54 while under buffer control.

The above thus describes the example of recording an input signal in the form of an analog signal output from the analog tuner 11. However, other examples of recording can also be given, such as the following.

(1) It is possible to record an external analog input signal acquired from the external equipment 2 via the analog input port 13.

(2) It is possible to use the DV decoder 15 to decode and acquire a DV signal from a DV-compatible digital video camera or similar external equipment 3 via the DV input port 14.

The sequence is similar for either of the above two cases.

A sequence will now be described for the case wherein, after being decoded, the externally-input digital signal (i.e., bitstream) is re-encoded into a digital recording format compatible with a particular recording medium, and then recorded thereto.

Upon receiving a digital television broadcast using the antenna 4, for example, the bitstream output from the digital tuner 16 is descrambled and demultiplexed into an audio signal and a video signal by the stream processor 30, and then input into the AV decoder 40. Subsequently, the digital video signal and the digital audio signal are decoded by the AV decoder 40.

The decoded digital video signal is resized to a predetermined picture size by the scaler 42 as appropriate, and then input into the AV encoder 20. Meanwhile, the decoded digital audio signal is converted to a predetermined number of channels by the audio processor 44 as appropriate, and then input into the AV encoder 20.

Subsequently, the converted digital audio/video signal are encoded (i.e., re-encoded) by the AV encoder 20, similar to the analog signal described above. The converted digital audio/video signals are then multiplexed and encrypted by the stream processor 30, and recorded onto a recording medium in the HDD 52 or the optical disc drive 54 while under buffer control.

In this way, when the input signal to be recorded is a compressed digital signal (i.e., stream), the signal is re-encoded when appropriate. In other words, the compressed digital signal is first decoded to stream data by the AV decoder 40, converted into different formats by the scaler 42 and the audio processor 44, re-encoded into a predetermined recording format compatible with a particular recording medium by the AV encoder 20, and then recorded onto that recording medium. It should also be appreciated that re-encoding may be omitted in the case where the input digital signal is originally in a predetermined format compatible with the recording medium.

The above thus describes the example of recording the audio/video signal of a digital broadcast output from the digital tuner 16. However, other examples of recording can also be given, such as the following.

(1) It is possible to recording an HDV signal (i.e., stream) acquired from an HDV video camera or similar external equipment 5 via the i.LINK port 17.

(2) It is possible to record an IPTV input stream received via the Ethernet network 7 and the communication unit 19.

(3) It is possible to read an external stream that has been directly recorded onto the HDD 52 or other recording medium. Herein, direct recording refers to recording, onto the HDD 52, an input stream acquired from external equipment 6 connected via the USB port 18, or the HD video stream of a received digital broadcast, for example.

(4) It is also possible to record a stream read from an optical disc in the optical disc drive 54 onto the HDD 52.

The sequence is similar for all of the above cases.

In addition, when recording various externally-provided content like that described above to a recording medium in the recording unit 50 of the recording and playback apparatus 10 in accordance with the present embodiment, the content to be recorded is also processed so as to extract feature point information and create a control routine.

More specifically, when recording content, the video signal of the content to be recorded is input into the feature point extraction block 60 from the stream processor 30. The video signal is analyzed by means of the feature point extraction block 60 and the CPU 170, and feature point information is extracted that expresses features of the entire video of the content to be recorded.

On the basis of the feature point information, a control routine is generated for controlling the output picture quality adjustment block 70 when adjusting the picture quality of the content during subsequent playbacks. The control routine is stored in the HDD 52 of the recording unit 50, for example.

In this way, when recording content with respect to the recording unit 50 in the recording and playback apparatus 10 in accordance with the present embodiment, control routines are created and recorded for each set of content, in accordance with the feature point information regarding the content video.

Playback operations performed by the recording and playback apparatus 10 configured as shown in FIG. 8 will now be described. Such playback operations are executed when playing back content that was recorded in the past, or during chase play, wherein content is played back from the beginning while the remainder is still in the process of being recorded.

First, the data (i.e., video, audio, and subtitle or other data) for the content to be played back is read from the recording medium on which the content is recorded by the HDD 52 or the optical disc drive 54 of the recording unit 50. The bitstream thus read is decrypted and demultiplexed into an audio stream and a video stream by the stream processor 30.

Next, the video stream and the audio stream (i.e., compressed data) are respectively decoded by the AV decoder 40. The decoded video stream (i.e., the playback video signal) is then input into the output picture quality adjustment block 70 and processed for picture quality adjustment.

At this point, the CPU 170 controls the output picture quality adjustment block 70 following the control routine earlier created for the current content on the basis of feature point information. In so doing, suitable picture quality adjustment is performed at suitable locations in the video of content to be played back.

Subsequently, on-screen display (OSD) or subtitle information for the content video is added to the adjusted video stream by the graphics processor 80. In addition, parameters such as the picture size of the video stream are adjusted by the display processor 82 to match the output format. The resulting video stream is then digitally output, or alternatively, input into the D/A converter 84.

Moreover, the display processor 82 does not simply apply 1D SBM to the input video signal. Instead, SBM is adaptively controlled by the CPU 170 on the basis of original source information and information regarding the final output. For example, the display processor 82 may deactivate SBM, or modify how SBM is conducted by switching the coefficients of a high-pass filter (HPF) according to the source.

Meanwhile, the audio stream output from the AV decoder 40 is subjected to predetermined audio processing as appropriate, and then input into the D/A converter 84.

As a result, the digital signals expressing the audio and video streams are respectively converted into analog signal by the D/A converter 84, and then output to external equipment such as the monitor 8 and the one or more speakers 9. The monitor 8 displays the video of the playback content, while the one or more speakers 9 output the audio of the playback content.

The recording and playback apparatus 10 in accordance with the present embodiment may also execute processing to extract and analyze feature point information with respect to content to be played back, even when playing back such content as described above.

For example, processing such as the extraction of feature point information is not conducted for content recorded onto a removable recording medium, such as when content is provided to the recording and playback apparatus 10 by a removable recording medium such as a retail DVD or BD.

Thus, in such cases, the extraction and processing of feature point information is executed when the content is played back (when the content is first played back, for example), and a control routine for adjusting the picture quality of the content is created.

More specifically, when the content is played back, the video signal of the content to be played back that is read from the recording unit 50 is input into the feature point extraction block 60 from the stream processor 30. Processing similar to that executed when recording content is then executed, wherein feature point information for the content to be played back is extracted on the basis of results from analysis of the video signal, a control routine is created on the basis of the feature point information, and the control routine is then recorded onto a recording medium in the recording unit 50. In so doing, the picture quality of the content to be played back is optimally adjusted on the basis of the control routine during subsequent playbacks of the content.

As described earlier, the image processing apparatus 100 in accordance with the present embodiment is configured to conduct SBM according to the properties of the source. In other words, in the present embodiment, 1D SBM is not simply applied to an input video signal, but instead adaptively controlled on the basis of original source information and information regarding the final output. For example, SBM can be deactivated, or SBM can be modified by switching the coefficients of a high-pass filter (HPF) according to the source.

Consequently, according to an embodiment of the present invention, the inappropriate application of error diffusion is prevented, and palette conversion functions are adaptively applied in accordance with the properties of the source. In other words, it becomes possible to adaptively utilize the advantages of SBM.

It is also possible to form the method detailed above as a program corresponding to the sequence described earlier and configured for execution by a CPU or similar computer. Moreover, such a program may be provided on a recording medium such as semiconductor memory, a magnetic disk, an optical disc, or a floppy disk, wherein the program is accessed and executed by a computer into which the recording medium has been set.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
a processing subsystem configured to perform various processing with respect to an original video source;
a palette converter configured to convert the palette bit depth, having modifiable palette conversion functions for creating the illusion of expressing the pre-conversion palette tones in the post-conversion image; and
a controller configured to turn on the palette converter, turn off the palette converter, or modify the palette conversion functions thereof, in accordance with at least original source information and system-wide settings information.

2. The image processing apparatus according to claim 1, wherein
the palette converter includes a filter configured to filter random noise that has been produced, in accordance with set filter coefficients, and
the controller modifies the filter coefficients of the filter according to the information.

3. The image processing apparatus according to claim 1 or 2, wherein
the controller controls automatic switching of bit length in the palette converter according to information from a television.

4. The image processing apparatus according to claim 3, wherein
the controller controls automatic switching of bit length in the palette converter using information obtained from monitor information during digital output.

5. The image processing apparatus according to any of claims 1 to 3, wherein
the controller turns on the palette converter, turns off the palette converter, or switches filter coefficients in the palette conversion functions thereof, in accordance with various information from the processing subsystem.

6. The image processing apparatus according to claim 5, wherein
the controller turns the palette converter on or off in accordance with usage information indicating whether digital out or analog out is being used.

7. The image processing apparatus according to claim 5 or 6, wherein
the controller modifies the filter coefficients in accordance with a digital or analog classification.

8. The image processing apparatus according to any of claims 1 to 7, wherein the palette converter includes
a dither adder configured to apply dithering to a target image by adding random noise to the pixel values forming the target image, and
a delta-sigma modulator configured to apply one-dimensional delta-sigma modulation to the dithered target image from the dither adder, and output an image made up of the resulting pixel values.

9. The image processing apparatus according to any of claims 1 to 8, wherein
the processing subsystem includes
a decoder configured to convert an original source into a video signal,
a picture quality adjuster configured to adjust the picture quality of the decoded video signal,
an I/P unit configured to convert the output of the picture quality adjuster from interlaced (I) to progressive (P) format, and supply the result to the palette converter, and
a feature analyzer configured to acquire feature point information regarding the video signal output from the I/P unit,
and wherein
the controller is configured to turn on the palette converter, turn off the palette converter, or modify the palette conversion functions thereof, in accordance with information from the decoder, the picture quality adjuster, the I/P unit, and the feature analyzer.

10. An image processing method, comprising the steps of:
performing various processing with respect to an original video source;
turning on a palette converter, turning off a palette converter, or modifying the palette conversion functions thereof, in accordance with at least original source information and system-wide settings information;
stopping the expression of the palette conversion functions when the palette converter has been turned off; and
when the palette converter has been turned on, converting the palette bit depth of the image signal subjected to the various processing so as to create the illusion of expressing the pre-conversion palette tones in the post-conversion image.

11. A program causing a computer to execute image processing comprising the steps of:
performing various processing with respect to an original video source;
turning on a palette converter, turning off a palette converter, or modifying the palette conversion functions thereof, in accordance with at least original source information and system-wide settings information;
stopping the expression of the palette conversion functions when the palette converter has been turned off; and
when the palette converter has been turned on, converting the palette bit depth of the image signal subjected to the various processing so as to create the illusion of expressing the pre-conversion palette tones in the post-conversion image.
